(19) United States
(12) Patent Application Publication
(10) Pub. No.: US 2011/0227488 A1
(43) Pub. Date: Sep. 22, 2011

(54) Road Lamp Structure Capable of Regulating Illumination Light Color

(76) Inventors: Shih-Jen LIAO, Taoyuan City (TW); Shih-Chieh Cheng, Taoyuan City (TW)

(21) Appl. No.: 12/727,905

(22) Filed: Mar. 19, 2010

(51) Int. Cl. H05B 37/02

(52) U.S. Cl. 315/159

(57) ABSTRACT

A road lamp structure capable of regulating illumination light color includes at least a road lamp body and a control module. The road lamp body includes an illumination light source and an auxiliary light source. An inside of the auxiliary light source contains a plurality of light emitting diodes (LEDs) with different wavelengths. The auxiliary light source can emit light colors at a wavelength range of 540 to 640 nm. The control module turns on or turns off the auxiliary light source under different environments for visible degrees, so as to provide clear illumination effect for users.

### BACKGROUND OF THE INVENTION

1. Field of the Invention

The present invention relates to a road lamp structure capable of regulating illumination light color under different environments for visible degrees.

2. Description of the Related Art

Surface water is evaporated into atmosphere to enable moisture content within air to rise. Once the humidity within air approximately reaches a saturation state, the moisture within atmosphere is condensed to water drops or sublimed to ice crystals. These water drops or ice crystals are affected by buoyancy of air to continuously float in the air. The water drops or the ice crystals are also called “fog” while floating near the ground or in the air above the sea surface.

A conventional road lamp structure is normally unable to regulate the colors of irradiated light with respect to weather changes such as fog, fire or smoke. However, the road lamp usually irradiates white color light. When a dense fog comes, the transmittance of the white color light is worse to cause low visibility during the driving. The road lamp may not effectively bring the illumination into full play. Moreover, more driving accidents may happen due to the low visibility to suffer much sorrow and to endanger the safety of users. The foregoing shortcomings necessarily need to be overcome.

### SUMMARY OF THE INVENTION

In view of the shortcomings of the conventional road lamp structures, the inventor of the present invention based on years of experience in the related industry to conduct extensive researches and experiments, and finally developed a road lamp structure capable of regulating illumination light color under different environemts for visible degrees.

Therefore, it is an objective of the present invention to overcome the aforementioned shortcoming and deficiency of the prior art by providing a road lamp structure capable of regulating illumination light color.

To achieve the foregoing objective, the road lamp structure provided by one embodiment of the present invention includes at least one road lamp body and a control module. The road lamp body includes an illumination light source and an auxiliary light source. An inside of the auxiliary light source contains a plurality of light emitting diodes with different wavelengths. The auxiliary light source can emit light colors at a wavelength range of 540 to 640 nm. The control module includes a sight line sensor and a processor. The processor is respectively connected to the auxiliary light source and the sight line sensor. The sight line sensor is disposed at an outside of the road lamp body to sense a visible degree of an environment and to generate a detection signal that is transmitted to the processor. The processor controls turning on/off the auxiliary light source and emits light colors with specifc wavelength based upon the detection signal.

When a dense fog comes or the visible degree is worse, fog lights, such as yellow or red light emitting diodes, are turned on. Yellow color light or red color light has better transmittance in the fog. Yellow control light or red color light can provide better visibility in the fog. When a fog does not lift, the illumination light source, such as white light emitting diodes, is turned on. Accordingly, clear illumination effect can be provided for users under different environments for visible degrees, so as to reduce the driving accidents and effectively enhance the utilization and driving safeties.

### BRIEF DESCRIPTION OF THE DRAWINGS

FIG. 1 is an appearance perspective view of a road lamp structure during fog-free in accordance with the present invention;

FIG. 2 is a structural schematic diagram of a road lamp structure in accordance with the present invention;

FIG. 3 is another structural schematic diagram of a road lamp structure in accordance with the present invention; and

FIG. 4 is an appearance perspective view of a road lamp structure in accordance with the present invention when fog comes.

### DETAILED DESCRIPTION OF THE PREFERRED EMBODIMENTS

The foregoing and other technical characteristics of the present invention will become apparent with the detailed description of the preferred embodiments and the illustration of the related drawings.

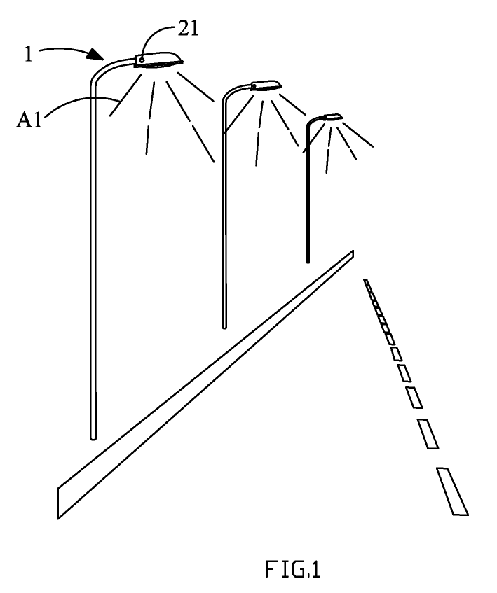

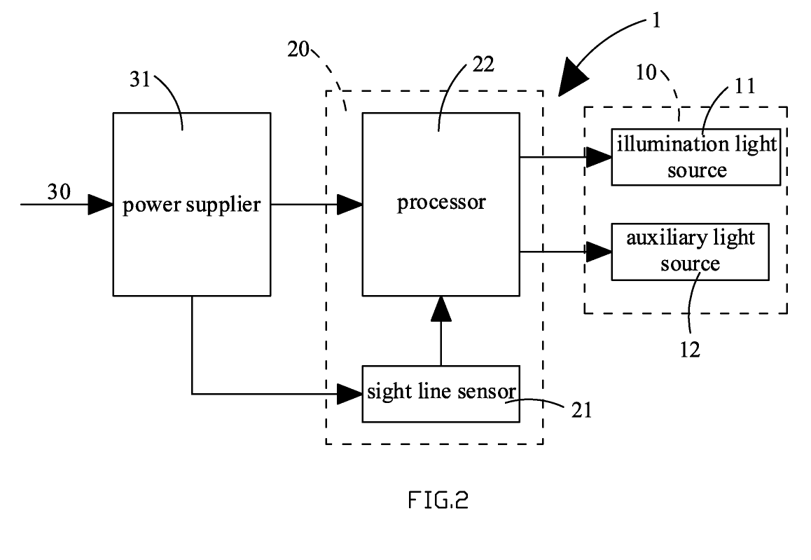

With reference to FIG. 1 and FIG. 2 for an appearance perspective view and a schematic diagram of a road lamp structure in accordance with a preferred embodiment of present invention are shown. As shown in these figures, the road lamp structure 1 in accordance with the embodiment at least comprises at least one road lamp body 10 and a control module 20.

The road lamp body 10 includes an illumination light source 11 and an auxiliary light source 12. The illumination light source 11 can be white light LEDs. An inside of the auxiliary light source 12 contains a plurality of LEDs (single-color green light, yellow light or red light LEDs as examples) with different wavelengths. The auxiliary light source 12 can emit light colors at a wavelength range of 540 to 640 nm.

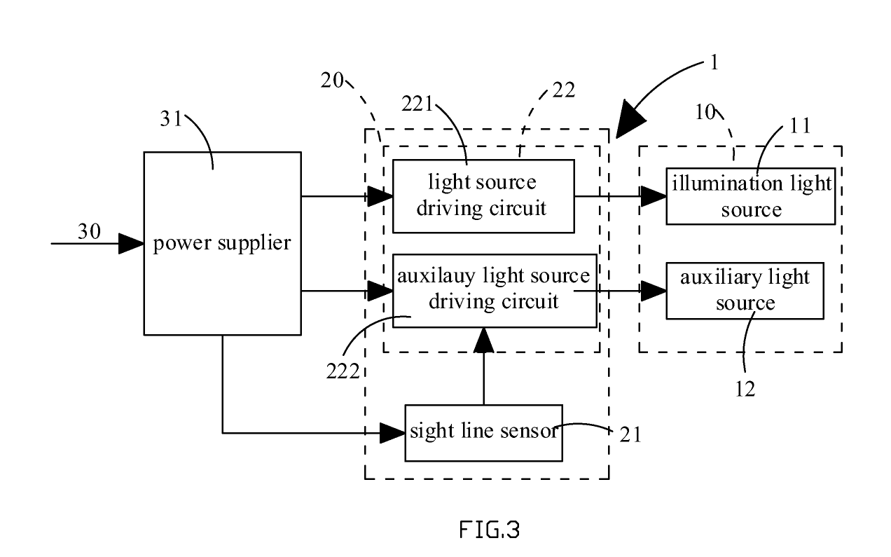

The control module 10 includes a sight line sensor 21 and a processor 22. The processor 22 is respectively connected to the auxiliary light source 12 and the sight line sensor 21. The sight line sensor 21 is disposed at an outside of the road lamp body 10. As shown in FIG. 3 in accordance with a second embodiment, an inside of the processor 22 further includes a light source driving circuit 221 and an auxiliary light source driving circuit 222 that are respectively connected to and provided for driving the illumination light source 11 and the auxiliary light source 12.

An external power source 30 is further provided. The external power source 30 further includes a power supplier 31. The control module 20 is connected to the external power source 30 through the power supplier 31.

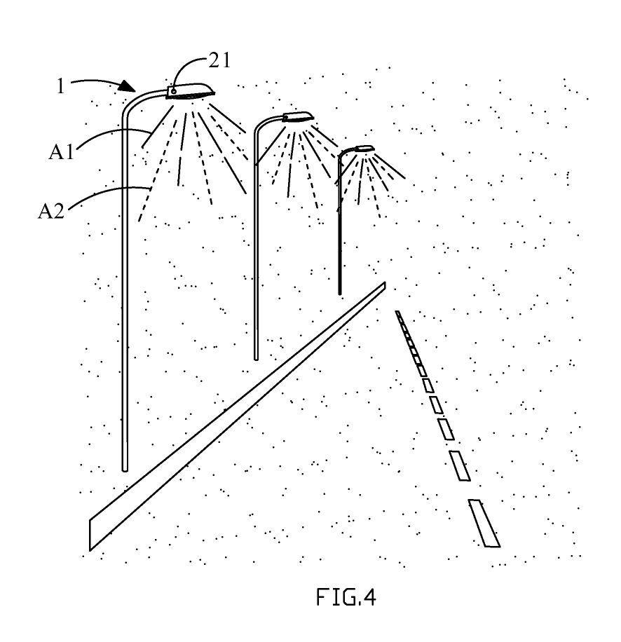

While in use, the power supplier 31 converts an alternating current (AC) power provided from the external power source 30 into a direct current (DC) constant voltage source, and the DC constant voltage source is provided to the control module 20. The DC constant voltage source is converted by the light source driving circuit 221 into a DC constant current source that is supplied to the illumination light source 11 for lighting. The sight line sensor 21 senses a visible degree of an environment to generate a detection signal. For instance, the signal can be interpreted as a distance that can be seen through pedestrians' or drivers' vision on the road. The value is one (100%) under a normal air quality or zero (0%) in a dense fog. An inside of the processor 22 includes a plurality of sight predetermined values (100 to 0%), and the processor 22 reads the detection signal provided by the sight line sensor 21 to determine whether or not the present visible degree is lower than the sight predetermined values. If the determination result is not, the current environment shows that fog does not lift or the visible degree is better, and the auxiliary light source 12 is still turned off. As shown in FIG. 1, the road lamp body 1 irradiates white color light A1 when fog does not lift. If the determination result is yes, the current environment shows that fog comes or the visible degree is worse, and the processor 22 would control the auxiliary light source 12 to emit light source with high transmittance. As shown in FIG. 4, the road lamp body 1 simultaneously irradiates white color light A1 and high transmittance color light A2 when fog comes, so as to provide better visibility in the dense fog.

Therefore, the road lamp structure of the present invention can regulate the illumination light color based on different ambient environments. Lights fog light sources such as yellow color or red color LEDs at a wavelength range of 540 to 640 nm are lighted up when a dense fog comes or the visible degree is worse. Yellow color light or red color light has better transmittance in the fog. When the fog does not lift, the illumination light source such as white light LEDs is lighted up, so as to provide clear illumination effect for users under different environments for visible degrees. Driving accidents are accordingly reduced to effectively enhance the utilization and driving safeties.

The present invention improves over the prior art and complies with patent application requirements, and thus is duly filed for patent application. While the invention has been described by device of specific embodiments, numerous modifications and variations could be made thereto by those generally skilled in the art without departing from the scope and spirit of the invention set forth in the claims.

What is claimed is:

1. A road lamp structure capable of regulating illumination light color at least comprising:
at least one road lamp body, the road lamp body having an illumination light source and an auxiliary light source, and the auxiliary light source containing a plurality of light emitting diodes (LEDs) with different wavelengths, and the auxiliary light source generating light colors at a wavelength range of 540 to 640 nm;
a control module having a sight line sensor and a processor, the processor respectively connected to the auxiliary light source and the sight line sensor, the sight line sensor disposed at an outside of the road lamp body to sense a visible degree of an environment and to generate a detection signal that is transmitted to the processor, the processor controlling turning on/off operation of the auxiliary light source based upon the detection signal.

2. The road lamp structure capable of regulating illumination light color as recited in claim 1, wherein an inside of the processor includes a plurality of sight predetermined values, and the processor controls the auxiliary light source to turn on or turn off and to generate light color with specifc wavelengths based upon a relationship between the detection signal and sight predetermined values.

3. The road lamp structure capable of regulating illumination light color as recited in claim 1, wherein the control module is connected to an external power source.

4. The road lamp structure capable of regulating illumination light color as recited in claim 3, wherein the external power source further includes a power source supplier.

5. The road lamp structure capable of regulating illumination light color as recited in claim 1, wherein an inside of the auxiliary light source contains single-color green light LEDs, yellow light LEDs or red light LEDs.

6. The road lamp structure capable of regulating illumination light color as recited in claim 5, wherein the illumination light source is a white light LED.

7. The road lamp structure capable of regulating illumination light color as recited in claim 1, wherein the inside of the processor further includes a light source driving circuit and an auxiliary light source driving circuit respectively connected to the illumination light source and the auxiliary light source.

8. The road lamp structure capable of regulating illumination light color as recited in claim 1, wherein the illumination light source is a white light LED.
